(19) United States
(12) Patent Application Publication
(10) Pub. No.: US 2016/0029439 A1
(43) Pub. Date: Jan. 28, 2016

(54) INDUCTION HEATER

(71) Applicant: Panasonic Intellectual Property Management Co., Ltd., Osaka-shi, Osaka (JP)

(72) Inventors: Yoichi KUROSE, Shiga (JP); Takeshi KITAIZUMI, Kyoto (JP)

(21) Appl. No.: 14/771,701

(22) PCT Filed: Apr. 4, 2014
(86) PCT No.: PCT/JP2014/001960

§ 371 Date: Aug. 31, 2015

(30) Foreign Application Priority Data
Apr. 10, 2013 (JP) 2013-081919

(51) Int. Cl. H05B 6/06; H05B 6/44; H05B 6/12

(52) U.S. Cl. CPC H05B 6/065; H05B 6/1209; H05B 6/44; H05B 2213/07

(57) ABSTRACT

An induction heater includes a plurality of heating coils, a plurality of inverters, a plurality of switching circuits, command unit, sensor group, and container detection unit. The number of inverters supplying a high-frequency current to the heating coils is less than the number of heating coils. Each of the switching circuits switches an electric path of each of the heating coils such that each heating coil is connected or not connected to any of the inverters. The command unit controls driving of the inverters and switching of the switching circuits. Each sensor in the sensor group detects a response of a resonance circuit including the heating coil relative to power supply from the inverters. The container detection unit detects whether or not heating target is placed on the heating coil based on an output of the sensor. This enables to retain safety and reduce cost of the induction heater equipped with the plurality of heating coils.

### TECHNICAL FIELD

The present invention relates to an induction heater, and more particularly to an induction heat cooking device that inductively heats a heating target, such as a cooking container, placed on a cooktop.

### BACKGROUND ART

In the induction heat cooking device, a method of controlling two heating coils with different resonance frequencies connected to a single inverter by adjusting a frequency of a high-frequency current supplied from the inverter is disclosed (e.g., PTL 1).

This method eliminates the need of inverters of the same number as that of heating coils, and thus the device cost can be reduced.

However, since a plurality of heating coils are connected to a single inverter, the high-frequency current for induction heat is constantly supplied to a heating coil on which no heating target is placed during induction heating.

Accordingly, a conduction loss occurs in the heating coil on which no heating target is placed, and thus heating efficiency may degrade. Noise interference with peripheral equipment may also occur due to a leaked magnetic field.

To solve the above disadvantage, one method, for example, is to connect and disconnect an electric path using a relay to block supply of the high-frequency current from the inverter to the heating coil not in use (e.g., PTL2).

This method allows supplying the high-frequency current only to a heating coil requiring it. Accordingly, a conduction loss due to unrequired power supply can be prevented, and generation of noise interference can be reduced.

Recently, an induction heat cooking device that can apply induction heat simultaneously to a plurality of heating targets placed on any places of a cooktop has been drawing attention (e.g., PTL3).

In this induction heat cooking device, many heating coils are disposed in matrix and a dedicated inverter is provided for each heating coil. Each inverter supplies the high-frequency current for detecting the presence of a heating target to a corresponding heating coil to identify one or more heating targets on the cooktop. Then, the high-frequency current for induction heating is supplied only to appropriate heating coil.

Naturally, the inverters of the same number as that of heating coils are required for an induction heating structure described in PTL3, and thus device cost increases.

Therefore, another method (e.g., PTL4) allocates one inverter to a plurality of heating coils and a switching circuit switches a heating coil to apply current, using the method described in PTL2.

However, the method disclosed in PTL4 cannot detect the presence of a heating target on the heating coil whose electric path with the inverter is disconnected. The state of placement of heating target on a cooktop cannot be recognized.

For simplification in the description, a high-frequency current for induction heating is hereinafter referred to as an induction heating current, determination of presence or absence of a heating target above the heating coil is referred to as container detection, and a high-frequency current that is extremely smaller than the induction heating current and supplied to the heating coil for the container detection is referred to as a container detecting current.

Moreover, points that should be accurately described as “a heating target is placed on a cooktop above the heating coil” or “a heating target is placed above the heating coil” in a precise sense is simply expressed, “a heating target is placed on the heating coil.”

### CITATION LIST

### Patent Literature 1

Japanese Patent Unexamined Publication No. 2012-124081

### Patent Literature 2

Japanese Patent Unexamined Publication No. H9-140561

### Patent Literature 3

U.S. Pat. No. 7,759,616

### Patent Literature 4

EP Patent Application No. 2380399

### SUMMARY OF THE INVENTION

The present invention solves disadvantages of the prior arts, and aims to offer an induction heater equipped with a plurality of heating coils and inverters of the number less than that of heating coils. The induction heater can inductively heat one or more heating targets placed on any places of the cooktop appropriately.

To solve the disadvantages of the prior arts, the induction heater of the present invention includes a cooktop on which a heating target is placed, a plurality of heating coils, a plurality of inverters, a plurality of switching circuits, a command unit, a sensor, and a container detection unit.

The plurality of heating coils are disposed beneath the cooktop, and include first and second heating coils. The plurality of inverters, which includes first and second inverters, supply power to the heating coils. The number of inverters is less than that of heating coils.

Each of the plurality of switching circuits switches an electric path so that each of the heating coils is connected to any of or none of the inverters.

The command unit controls power supply from the inverters and switchover of the switching circuits.

The sensor detects a response of a resonance circuit including the heating coils relative to power supply from the inverters. The container detection unit detects presence of the heating target on the heating coil based on an output of the sensor.

In particular, in the induction heater of the present invention, when the container detection unit detects presence of the heating target on the first heating coil and absence of the heating target on the second heating coil in the case at least the first and second heating coils form electric paths with the first inverter, the command unit switches the switching circuit not to connect the first heating coil or the second heating coil to the first inverter.

The present invention enables to supply the induction heating current only to the heating coil on which the heating target is placed and supply the container detecting current to the heating coil on which no heating target is placed, without providing the inverters of the same number as that of the heating coils.

When another heating target is further placed on the heating coil on which no heating target is placed, a new electric path is formed with other inverter by the switching circuit to apply induction heat separately.

In this way, the induction heater equipped with the plurality of heating coils and the inverters of the number less than that of heating coils can inductively heat one or more heating targets placed on any places appropriately, while preventing a conduction loss due to unrequired power supply and suppressing a leaked magnetic field.

### BRIEF DESCRIPTION OF THE DRAWINGS

FIG. 1 is a schematic top view of an induction heater in accordance with a first exemplary embodiment.

FIG. 2 is a circuit block diagram of the induction heater in accordance with the first exemplary embodiment.

FIG. 3 illustrates a position to place a heating target on the induction heater in accordance with the first exemplary embodiment.

FIG. 4 illustrates a state of a switching circuit in accordance with the first exemplary embodiment.

FIG. 5 illustrates a position to place a heating target on an induction heater in accordance with a second exemplary embodiment.

FIG. 6 illustrates a state of a switching circuit in accordance with the second exemplary embodiment.

FIG. 7 illustrates a position to place a heating target on an induction heater in accordance with a third exemplary embodiment of the present invention.

FIG. 8 illustrates states of switching circuits in accordance with the third exemplary embodiment.

FIG. 9 illustrates layout of heating coils and grouping of the heating coils in an induction heater in accordance with a fourth exemplary embodiment.

FIG. 10 is a circuit block diagram of the induction heater in accordance with the fourth exemplary embodiment.

FIG. 11 is a magnified view illustrating a placement position of a heating target and grouping of heating coils in the induction heater in accordance with the fourth exemplary embodiment.

FIG. 12 is a magnified view illustrating a position to place a heating target and grouping of heating coils in accordance with the fourth exemplary embodiment.

FIG. 13 is a circuit block diagram of an induction heater in accordance with a fifth exemplary embodiment.

### DETAILED DESCRIPTION OF THE PREFERRED EMBODIMENT

An induction heater according to the first invention includes a cooktop on which a heating target is placed, a plurality of heating coils, a plurality of inverters, a plurality of switching circuits, a command unit, a sensor, and a container detection unit.

The plurality of heating coils, which include first and second heating coils, are disposed beneath the cooktop. The plurality of inverters, which at least include first and second inverters, supply power to the heating coils. The number of inverters is less than that of heating coils.

The plurality of switching circuits switch an electric path of each heating coil to connect or not connect the heating coils to any of the inverters.

The command unit controls power supply from the inverters and switching of the switching circuits.

The sensor detects a response of a resonance circuit including heating coil relative to power supply from the inverters. The container detection unit detects presence of the heating target on the heating coil based on a sensor output.

In the induction heater of the present invention configured such that at least the first and second heating coils form electric paths with the first inverter, the command unit switches the switching circuits so as not to connect the first heating coil or the second heating coil to the first inverter when the container detection unit detects that the heating target is placed on the first heating coil and the heating target is not placed on the second heating coil.

The present invention supplies induction heating current only to the heating coil on which a heating target is placed and supplies container detecting current to the heating coil on which no heating target is placed, without providing the same number of inverters as that of the heating coils in the induction heater equipped with the plurality of heating coils.

If another heating target is further placed on the heating coil on which a heating target is not placed, an electric path with another inverter is additionally formed by the switching circuit to inductively heat it separately.

Accordingly, the induction heater equipped with the plurality of heating coils and inverters of the number less than that of heating coils can appropriately apply induction heat to one or more heating targets placed on designated areas while preventing a conduction loss due to unrequired power supply and suppressing a leaked magnetic field.

In addition, from a viewpoint of cost and component layout, the present invention is effective for an induction heater equipped with many heating coils aligned in matrix.

In the second invention, the command unit in the first invention switches the switching circuits to form an electric path between the first heating coil and the first inverter, and an electric path between the second heating coil and the second inverter.

This enables the heating coil on which no heating target is placed to form a separate electric path from that of the heating coil on which a heating target is placed and to which the induction heating current is supplied. The container detecting current can thus be supplied from a different inverter.

In the third invention, the command unit in the first invention switches the switching circuits to form an electric path between two or more adjacent heating coils and the first inverter when the container detection unit determines that a single heating target is placed on two or more adjacent heating coils.

The invention can supply the induction heating current from a single inverter to the plurality of heating coils heating the single heating target by allocating the single inverter.

In the fourth invention, the command unit in the third invention switches the switching circuits to form an electric path between at least one of two or more heating coils and the second inverter if power supplied from the first inverter to two or more adjacent heating coils exceeds a specified level.

The invention enables to supply the induction heating current from the plurality of inverters to the heating coils for applying induction heat to a large cooking container extending over many heating coils.

This enables the use of many inverters with relatively small output, improving design flexibility.

When inverters with relatively small output are used, a cooling function for the switching element may be omitted. Accordingly, from a viewpoint of cost and design flexibility, the present invention is effective for induction heaters equipped with many heating coils aligned in matrix.

In the fifth invention, the command unit in the first invention switches the switching circuits not to form an electric path between the heating coil on which no heating target is placed and any of the inverters, when all inverters are operated.

The invention enables the maximum effective use of inverters of the number less than that of heating coils. For example, assuming that one heating target is placed on one heating coil, induction heating can be separately applied to the number of heating targets same as that of inverters.

The sixth invention further includes an auxiliary circuit that can supply container detecting current but not induction heating current. The command unit in the fifth invention switches the switching circuits to form an electric path between the heating coil on which no heating target is placed and the auxiliary circuit.

The invention eliminates the need of using an inverter for detecting the container, and thus the container can be detected even if all inverters are supplying induction heating current. Accordingly, placement of all heating targets can be identified in any operation state of inverters.

The seventh invention further includes an operation panel for giving instructions for starting and stopping heating to the command unit in the first invention. The command unit switches the switching circuits relative to an instruction for starting heating from the operation panel.

The invention is, in particular, effective for induction heaters equipped with many heating coils aligned in matrix. In these induction heaters, heating targets can be placed on any area on the cooktop. For example, a heating target once placed may be moved to another immediately afterward, and thus heating does not always start at the place where the heating target is placed first.

The invention can eliminate the operation of unrequired switching of the switching circuits. As a result, noise at switchover can be prevented, and thus probable failure can be reduced.

Exemplary embodiments of the present invention are described below with reference to drawings. In the drawings, same reference marks are given to same or corresponding components to omit their duplicate description.

### First Exemplary Embodiment

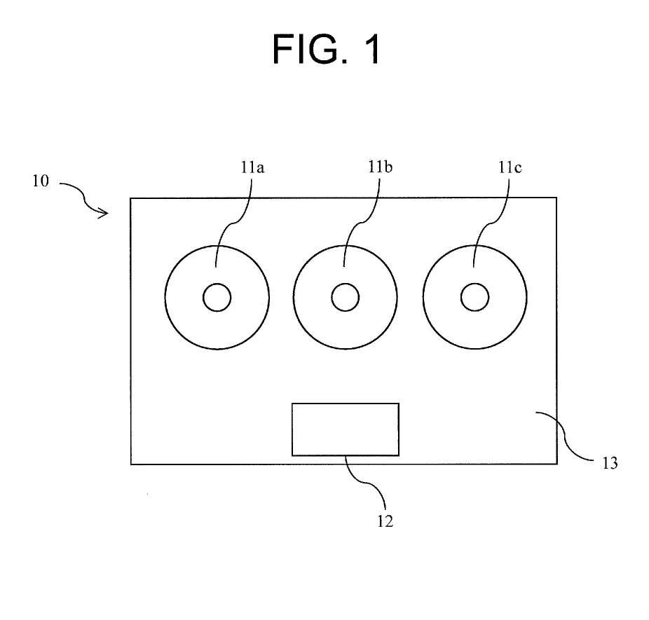

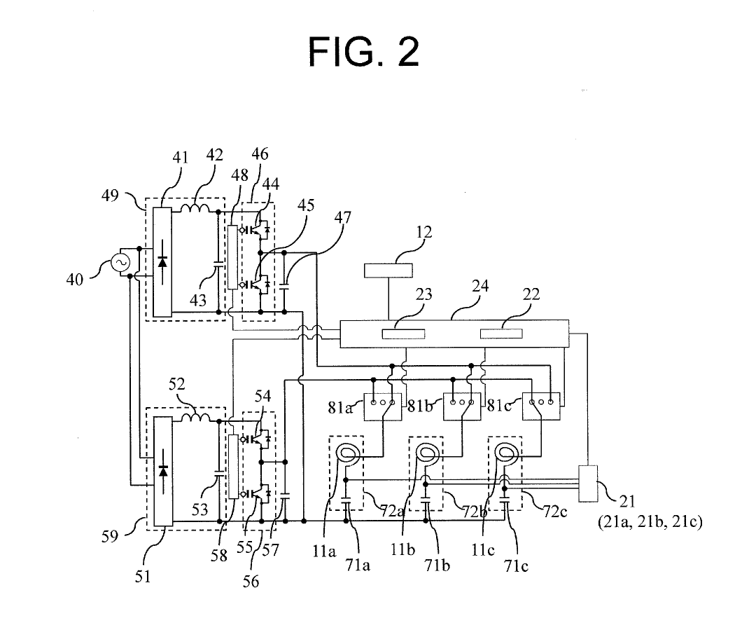

FIG. 1 is a schematic top view of an induction heater in the first exemplary embodiment. FIG. 2 is a circuit block diagram of the induction heater in the exemplary embodiment.

Components and circuit configuration of induction heater 10 in the exemplary embodiment are detailed below with reference to FIGS. 1 and 2.

Induction heater 10 in the first exemplary embodiment includes flat cooktop 13 on its top face. Cooktop 13 is configured with an electric insulating material, such as glass and ceramic, for placing a heating target, such as a pan.

Induction heater 10 includes DC power source 49 having diode bridge 41, choke coil 42, and smoothing capacitor 43, and DC power source 59 having diode bridge 51, choke coil 52, and smoothing capacitor 53 for rectifying and smoothing the power from commercial AC power source 40.

A negative bus bar of DC power source 59 is connected to a negative bus bar of DC power source 49, and has a potential same as that of the negative bus bar of DC power source 49.

Induction heater 10 includes three heating coils (heating coil 11a, heating coil 11b, and heating coil 11c) with practically the same shape and structure. These heating coils are horizontally aligned beneath cooktop 13. Heating coil 11a corresponds to a first heating coil, and heating coil 11b corresponds to a second heating coil.

A high-frequency magnetic field generated by applying a high-frequency current to the heating coils is transmitted to a heating target, such as a metal pan, and causes eddy current in the heating target. Induction heating takes place by generating heat corresponding to the size of this eddy current and specific resistance of the heating target.

Induction heater 10 includes three resonance circuits (resonance circuit 72a, resonance circuit 72b, and resonance circuit 72c). Resonance circuit 72a is configured with heating coil 11a and resonance capacitor 71a connected in series. One end of resonance circuit 72a is connected to the negative bus bar of DC power source.

In the same way, resonance circuit 72b is configured with heating coil 11b and resonance capacitor 71b connected in series. One end of resonance circuit 72b is connected to the negative bus bar of DC power source. Resonance circuit 72c is configured with heating coil 11c and resonance capacitor 71c connected in series. One end of resonance circuit 72c is connected to the negative bus bar of DC power source.

Induction heater 10 includes inverter 46 that is a first inverter and inverter 56 that is a second inverter.

Inverter 46 is configured with switching element 44, to which a reverse conducting diode is connected in parallel, and switching element 45, to which a reverse conducting diode is connected in parallel, are connected in series.

In the same way, inverter 56 is configured with switching element 54, to which a reverse conducting diode is connected in parallel, and switching element 55, to which a reverse conducting diode is connected in parallel, are connected in series.

Drive circuit 48 drives inverter 46 by controlling to supply power to switching elements 44 and 45. Drive circuit 58 drives inverter 56 by controlling to supply power to switching elements 54 and 55.

Induction heater 10 includes three switching circuits (switching circuit 81a, switching circuit 81b, and switching circuit 81c).

Switching circuit 81a selects connection of the other end of resonance circuit 72a to a contact point of switching element 44 and switching element 45 or a contact point of switching element 54 and switching element 55, or no connection based on a command from command unit 23 to determine an electric path of heating coil 11a.

Switching circuit 81b selects connection of the other end of resonance circuit 72b to a contact point of switching element 44 and switching element 45 or a contact point of switching element 54 and switching element 55, or no connection, based on a command from command unit 23 to determine an electric path of heating coil 11b.

Switching circuit 81c selects connection of the other end of resonance circuit 72c to a contact point of switching element 44 and switching element 45 or a contact point of switching element 54 and switching element 55, or no connection based on a command from command unit 23 to determine an electric path of heating coil 11c.

In other words, if one ends of heating coils 11a to 11c are connected to the contact point of switching element 44 and switching element 45 by switching circuits 81a to 81c, respectively, the heating coils 11a to 11c are connected to inverter 46 in parallel. If one ends of heating coils 11a to 11c are connected to the contact point of switching element 54 and switching element 55, the heating coils 11a to 11c are connected to inverter 56 in parallel.

In FIG. 2, resonance circuit 72a forms an electric path with inverter 46 via switching circuit 81a. Resonance circuit 72b forms an electric path with inverter 46 via switching circuit 81b. Resonance circuit 72c configures an electric path with inverter 56 via switching circuit 81c.

Induction heater 10 has sensor group 21 that includes sensor 21a for resonance circuit 72a, sensor 21b for resonance circuit 72b, and sensor 21c for resonance circuit 72c.

Sensor 21a detects voltage generated in resonance capacitor 71a and current running in resonance circuit 72a.

In the same way, sensor 21b detects voltage generated in resonance capacitor 71b and current running in resonance circuit 72b. Sensor 21c detects voltage generated in resonance capacitor 71c and current running in resonance circuit 72c.

In the exemplary embodiment, voltage generated in the resonance capacitor and current running in the resonance circuit are detected in response to power supplied to heating coils 11a, 11b, and 11c. However, as long as placement of a heating target can be detected, the exemplary embodiment does not limit the type of physical quantity to be detected and detecting place.

When the current running in the resonance circuit is detected, sensors 21a, 21b, and 21c converts current to voltage that can be processed by a comparator or microcomputer by using, for example, current transformer. To detect high voltage, voltage-dividing resistance is used to detect a low voltage in proportion to actual voltage so that the voltage can be dropped to the level that can be processed by the comparator or microcomputer.

Container detection unit 22 determines the presence of heating target, such as a pan, on each of heating coils 11a, 11b, and 11c based on detection results of sensors 21a to 21c.

For a heating coil on which a heating target is placed but induction heating has not yet started, container detection unit 22 handles in the same way as a heating coil on which no heating target is placed, and supplies the container detecting current. Therefore, if the heating target is moved before starting induction heating, container detection unit 22 can recognize this change.

In other words, container detection unit 22 sequentially and repeatedly supplies the container detecting current for detecting a cooking container to a heating coil without heating target and a heating coil with heating target but not yet heated.

If the heating target is moved, a response from the resonance circuit relative to the supplied induction heating current changes in a heating coil applying induction heat to a heating target placed on it. Container detection unit 22 reads this change based on an output from the sensor, and can thus recognize movement of the heating target.

In this case, based on a container detection result of container detection unit 22, command unit 23 outputs an instruction signal to stop heating, which is described later.

Operation panel 12 is provided near the center of cooktop 13 at the side of user (bottom side in FIG. 1), and outputs a command signal, such as heating start or stop and power adjustment, according to the user's operation.

Command unit 23 receives the command signal from operation panel 12, and outputs a drive signal to drive circuit 48 for driving inverter 46 and drive circuit 58 for driving inverter 56 according to the command signal from operation panel 12.

Command unit 23 outputs a signal for switching connection of switching circuits 81a to 81c based on the detection result of container detection unit 22. Container detection unit 22 and command unit 23 are configured with software and included in control unit 24 configured with a microcomputer.

Snubber capacitor 47 is connected to switching element 45 in parallel for reducing a switching loss that occurs when switching element 44 and switching element 45 are turned off.

In the same way, snubber capacitor 57 is connected to switching element 55 in parallel for reducing a switching loss that occurs when switching element 54 and switching element 55 are turned off.

The operation of induction heater 10 in the exemplary embodiment is described below.

Connection states of switching circuits 81a to 81c shown in FIG. 2 are the initial states of switching circuits 81a to 81c. In other words, they are the connection states when the main power (not illustrated) is turned on. As shown in FIG. 1, no heating target is placed on cooktop 13 at turning on the main power.

When the main power is turned on, inverter 46 starts to supply the container detecting current to resonance circuits 72a and 72b, and inverter 56 to resonance circuits 72c, according to the initial states of switching circuits 81a to 81c.

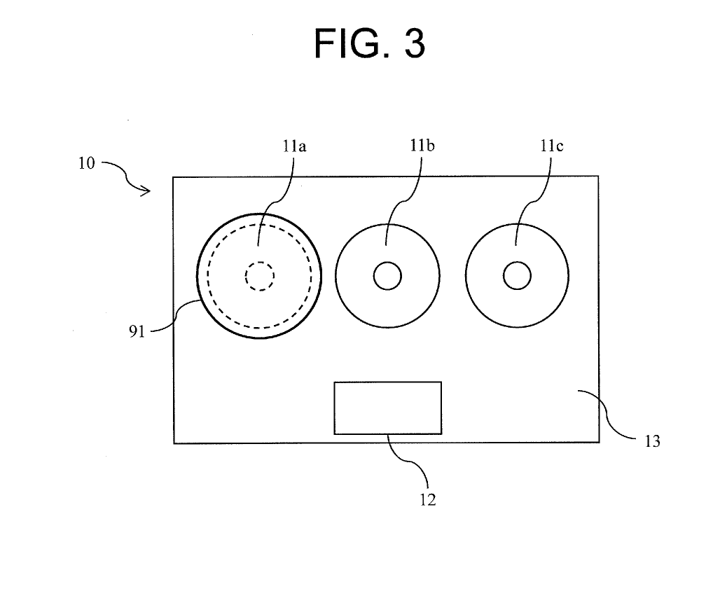

FIG. 3 shows the state that heating target 91 is placed on heating coil 11a of induction heater 10 in FIG. 1.

If heating target 91 is placed on heating coil 11a in the initial states of switching circuits 81a to 81c shown in FIG. 2, sensor 21a detects current of resonance circuit 72a and voltage of resonance capacitor 71a corresponding to the container detecting current supplied from inverter 46. Container detection unit 22 determines that heating target 91 is placed on heating coil 11a based on the output from sensor 21a.

In the same way as resonance circuit 72a, inverter 46 also supplies the container detecting current to resonance circuit 72b. Container detection unit 22 determines that a heating target is not placed on heating coil 11b based on the output from sensor 21b.

Inverter 56 supplies the container detecting current to resonance circuit 72c, and container detection unit 22 determines that no heating target is placed on heating coil 11c based on the output from sensor 21c.

According to the detection result of container detection unit 22, command unit 23 switches switching circuit 81b so that heating coil 11a on which heating target 91 is placed and heating coil 11b on which no heating target 91 is placed do not form electric paths with the same inverter.

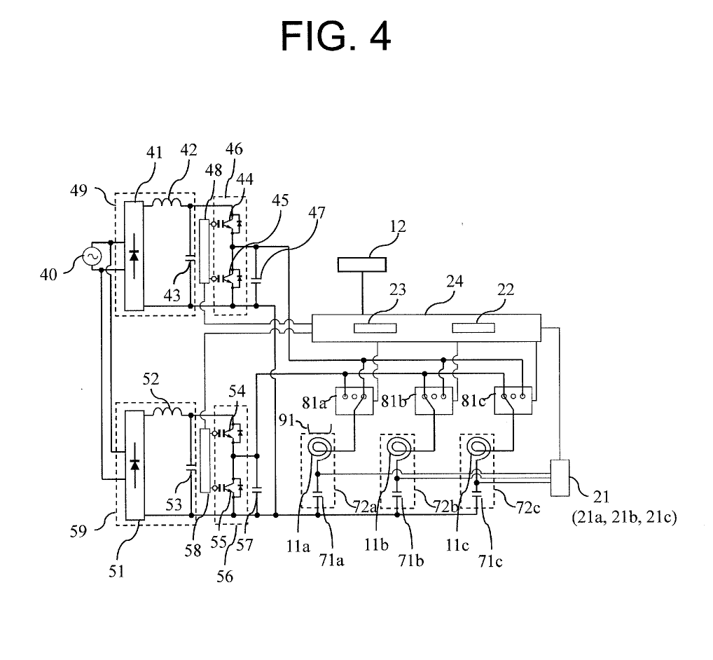

FIG. 4 shows the state that electric paths are determined by switching circuits 81a to 81c as described above in the circuit configuration of induction heater 10 shown in FIG. 2.

As shown in FIG. 4, heating target 91 is placed on heating coil 11a. Inverter 46 forms an electric path only with resonance circuit 72a, and inverter 56 forms electric paths with resonance circuits 72b and 72c by switching circuits 81 to 81c.

If heating starts via operation panel 12 in this state, command unit 23 makes inverter 46 start supplying the induction heating current to heating coil 11a. In this way, induction heater 10 drives heating coil 11a by inverter 46 to apply induction heat to heating target 91.

To monitor whether or not another heating target is placed on heating coil 11b or 11c during induction heating, command unit 23 makes inverter 56 supply the container detecting current to heating coils 11b and 11c repeatedly.

In the exemplary embodiment, in induction heater 10 equipped with inverters of the number less than that of heating coils, inverter 46 supplies the induction heating current only to heating coil 11a on which heating target 91 is placed, and inverter 56 supplies the container detecting current to heating coils 11b and 11c.

This prevents a conduction loss due to supply of unrequired induction heating current to heating coils without heating targets, and suppresses a leaked magnetic field.

Since the container detecting current is supplied to the heating coils on which no heating target is placed, placement of another heating target on one of these heating coils can be detected.

If switching circuit 81b executes its switching operation in response to container detection by container detection unit 22, it may be executed, in response to a command signal for starting heating from command unit 23.

In the former case, the switching operation takes place every time the heating target is moved, and thus this may be a wasteful operation. For example, if the switching circuit is a relay circuit, unrequired switching operation increases a risk of failure in addition to a clicking noise generated every time. Accordingly, command unit 23 preferably switches the switching circuit immediately before starting heating in response to an instruction for starting heating from operation panel 12.

In the exemplary embodiment, switching circuit 81b is switched to retain the electric path between heating coil 11a on which heating target 91 is placed and inverter 46, and form the electric path between heating coil 11b on which no heating target 91 is placed and inverter 56. However, the present invention is not limited to the structure of the exemplary embodiment.

For example, switching circuit 81a may be switched to retain the electric path between heating coil 11b on which heating target 91 is not placed and inverter 46, and forms the electric path between heating coil 11 on which heating target 91 is placed and inverter 56. This also achieves the same effect as that of the exemplary embodiment.

### Second Exemplary Embodiment

An induction heater in the second exemplary embodiment of the present invention is described below.

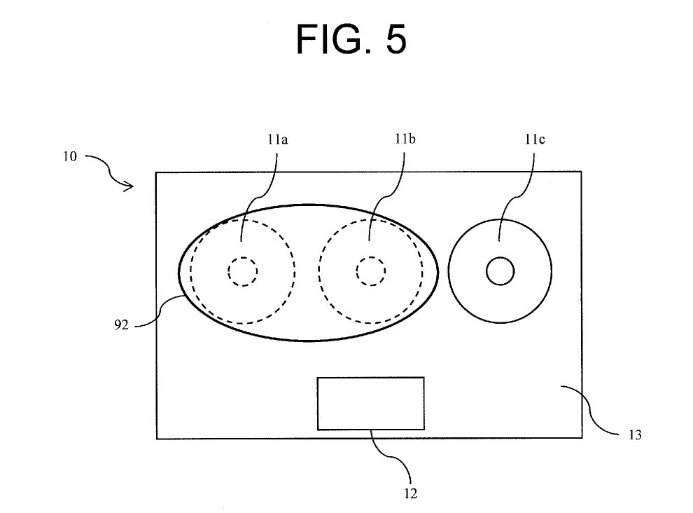

FIG. 5 shows the state that heating target 92 wider than heating target 91 is placed across heating coils 11a and 11b of induction heater 10 shown in FIG. 1.

Also in this case, same as the case in the first exemplary embodiment, inverter 46 starts to supply the container detecting current to resonance circuits 72a and 72b and inverter 56 to resonance circuit 72c according to the initial state of switching circuits 81a to 81c shown in FIG. 2.

When single heating target 92 is placed on heating coils 11a and 11b in the initial state of switching circuits 81a to 81c shown in FIG. 2, sensor 21a detects current of resonance circuit 72a and voltage of resonance capacitor 71a corresponding to the container detecting current supplied from inverter 46. Container detection unit 22 determines that heating target 91 is placed on heating coil 11a based on the output from sensor 21a.

In the same way, inverter 46 also supplies the container detecting current to resonance circuit 72b, and container detection unit 22 determines that the heating target is also placed on heating coil 11b based on the output from sensor 21b.

Furthermore, since container detection of heating coil 11b and container detection of heating coil 11a are almost at the same time, container detection unit 22 recognizes that single heating target 92 is placed on heating coils 11a and 11b.

Inverter 56 supplies the container detecting current to resonance circuit 72c, but container detection unit 22 determines that there is no heating target on heating coil 11c based on the output from sensor 21c.

Based on the detection result of container detection unit 22, command unit 23 retains the states of switching circuits 81a to 81c such that heating coils 11a and 11b on which single heating target 92 is placed continue to form the electric path with inverter 46 and heating coil 11c continues to configure the electric path with inverter 56.

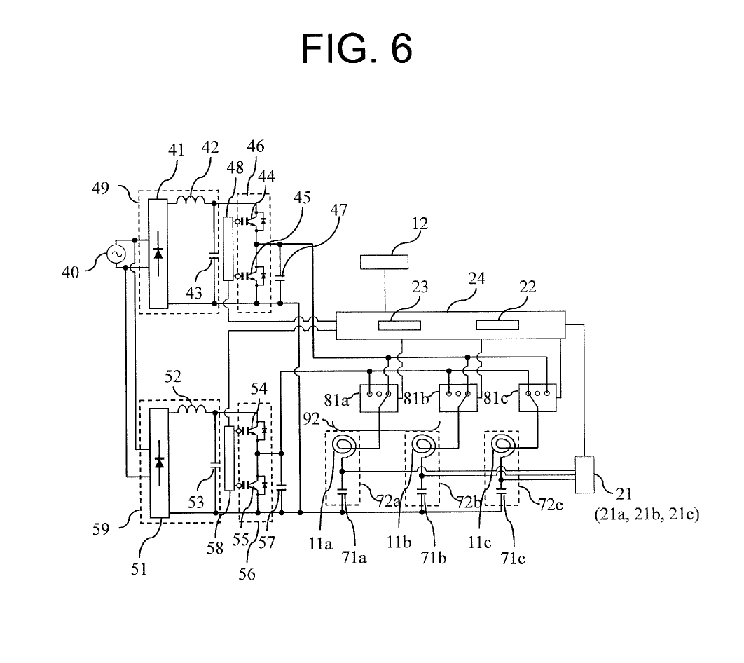

FIG. 6 shows the state that the electric paths are determined by switching circuits 81a to 81c in the circuit configuration of induction heater 10 shown in FIG. 2.

As shown in FIG. 6, single heating target 92 is placed on heating coils 11a and 11b, and inverter 46 forms the electric path with resonance circuits 72a and 72b and inverter 56 forms the electric path with resonance circuit 72c via switching circuits 81a to 81c.

When starting of heating is instructed via operation panel 12 in this state, command unit 23 makes inverter 46 start supplying the induction heating current to heating coils 11a and 11b. Accordingly, induction heater 10 drives heating coils 11a and 11b by inverter 46 to apply induction heat to heating target 92.

During induction heating, command unit 23 makes inverter 56 repeatedly supply the container detecting current to heating coil 11c, so as to monitor placement of another heating target on heating coil 11c.

In induction heater 10 equipped with inverters of the number less than that of heating coils in the exemplary embodiment, inverter 46 supplies the induction heating current to heating coils 11a and 11b on which wide heating target 92 is placed, and inverter 56 supplies the container detecting current to heating coil 11c.

This prevents a conduction loss due to supply of the unrequired induction heating current to the heating coil without any heating target and suppresses a leaked magnetic field.

Since the container detecting current is supplied to the heating coil on which no heating target is placed, placement of other heating target on this heating coil is detectable.

Accordingly, when another heating target is placed on heating coil 11c, inverter 56 can additionally apply induction heat to it.

Whether the heating target placed on heating coil 11a and the heating target placed on heating coil 11b are a single heating target or separate heating targets can be determined, as described above, based on time interval between container detection on heating coil 11a and container detection on heating coil 11b.

In case of the single heating target, the heating target is placed on heating coils 11a and 11b almost simultaneously, and thus two container detections take place almost at the same time. If not, there will normally be a time lag between two container detections.

With this method of determination, container detection unit 22 may result in erroneous determination if two heating targets are intentionally or accidentally placed at the same time.

However, in this exemplary embodiment, container detection unit 22 makes determination based on current and voltage obtained from the resonance circuits, and thus a difference in materials of heating targets is also detectable. If two heating targets are configured with different metals, container detection unit 22 can achieve proper container detection.

In the exemplary embodiment, all heating coils can be driven for induction heating only by a single inverter even if a single heating target is placed across all three heating coils.

However, in order to drive many heating coils with the single inverter, an inverter with larger output is needed as the number of heating coils increases.

For example, in the case of an induction heater equipped with four heating coils, each of which having 1 kW of rated power, and two inverters, a 4-kW inverter is needed for driving all heating coils with single inverter. This leads to an increase of product cost.

To solve this disadvantage, for example, a switching circuit forms an electric path to drive two of the four heating coils by one inverter, and remaining two heating coils by the other inverter. This enables the use of a component that can supply 2-kW power to each inverter, and thus cost can be suppressed.

As described above, whether to use a single inverter or a plurality of inverters for applying induction heat to a single heating target placed across a plurality of heating coils can be flexibly determined by programming in the command unit in accordance with specifications of heating coils and inverters to be used.

### Third Exemplary Embodiment

An induction heater in the third exemplary embodiment of the present invention is described below.

The operation of induction heater 10 is described when another heating target 93 is placed on heating coil 11 b in the state shown in FIGS. 3 and 4.

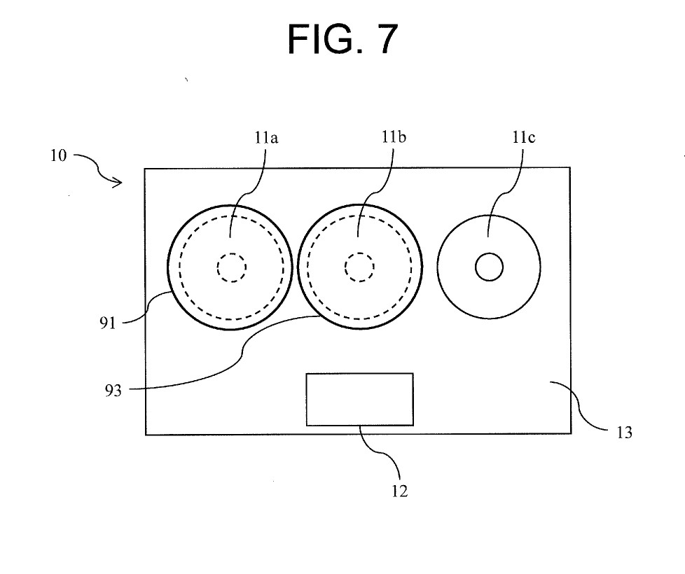

FIG. 7 shows the state that another heating target 91 is placed on heating coil 11b of induction heater 10 shown in FIG. 3.

When another heating target 93 is placed on heating coil 11b in the state of switching circuits 81a to 81c shown in FIG. 4, sensor 21b detects current of resonance circuit 72b corresponding to the container detecting current supplied from inverter 56 and voltage of resonance capacitor 71b. Container detection unit 22 then determines that a heating target is also placed on heating coil 11b based on an output of sensor 21b.

At the same time, since heating target 91 is already placed on heating coil 11a, container detection unit 22 recognizes that the heating target placed on heating coil 11b is heating target 93 different from heating target 91.

In the same way, the container detecting current is supplied from inverter 56 also to resonance circuit 72c, but container detection unit 22 determines that no heating target is placed on heating coil 11c based on an output of sensor 21c.

Based on a detection result of container detection unit 22, command unit 23 retains the states of switching circuits 81a and 81b and only switches the state of switching circuit 81c so that heating coils 11a and 11b on which heating targets 91 and 93 are placed continue to form electric paths with inverters 46 and 56, respectively, and heating coil 11c does not form an electric path with any of the inverters.

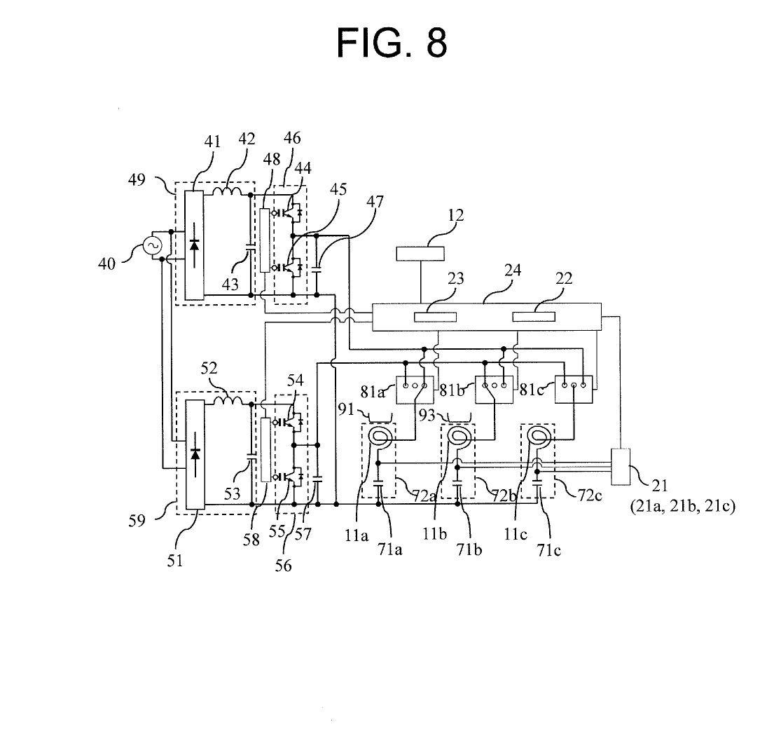

FIG. 8 shows the state that electric paths are determined by switching circuits 81a to 81c, as described above, in the circuit configuration of induction heater 10 shown in FIG. 2.

As shown in FIG. 8, heating targets 91 and 93 are placed on heating coils 11a and 11b, respectively. Inverters 46 and 56 configure an electric path with resonance circuits 72a and 72b, respectively. Heating coil 11c does not configure an electric path with any of the inverters.

When an instruction for starting heating is given via operation panel 12 in this state, command unit 23 starts to supply the induction heating current to drive circuit 58 for driving inverter 56, so as to supply the induction heating current to heating coil 11b. In this way, induction heater 10 drives heating coils 11a and 11b by using inverters 46 and 56, respectively, to separately apply induction heat to heating targets 91 and 93.

Since heating coil 11c does not form an electric path with any of the inverters during induction heating, the induction heating current is not supplied to heating coil 11c.

Accordingly, the exemplary embodiment enables to apply induction heat to heating targets of the number same as that of inverters in induction heater 10 equipped with inverters of the number less than that of heating coils.

Still more, the induction heating current is not supplied to a heating coil on which no heating target is placed. This prevents an induction loss due to supply of the unrequired induction heating current, and suppresses a leaked magnetic field.

Same as the first exemplary embodiment, switching circuit 81c may be switched in response to container detection by container detection unit 22 or in response to a command signal for starting heating by command unit.

In the former case, the switching operation takes place every time the heating target is moved, and thus this may be a wasteful operation. For example, if a switching circuit is a relay circuit, unrequired switching operation increases a risk of failure in addition to a clicking noise generated every time. Accordingly, command unit 23 preferably switches the switching circuit immediately before starting heating in response to an instruction for starting heating from operation panel 12.

### Fourth Exemplary Embodiment

An induction heater in the fourth exemplary embodiment of the present invention is described below.

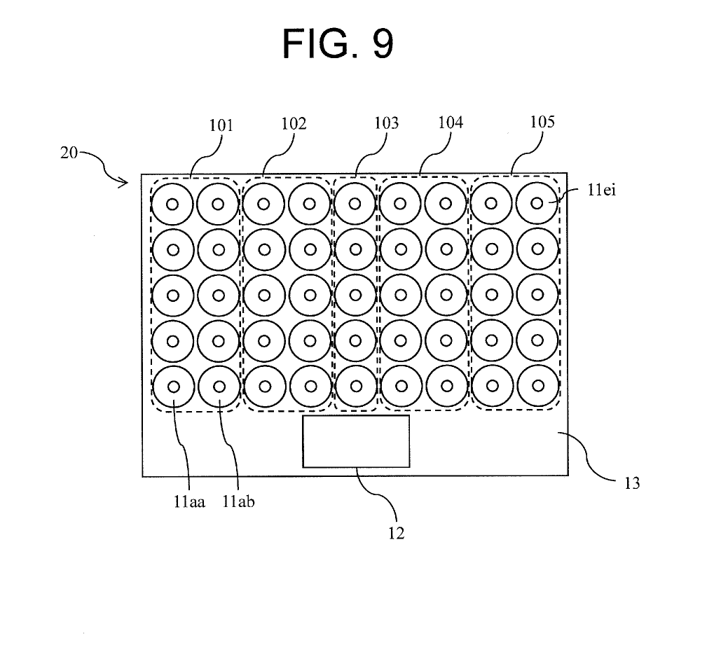

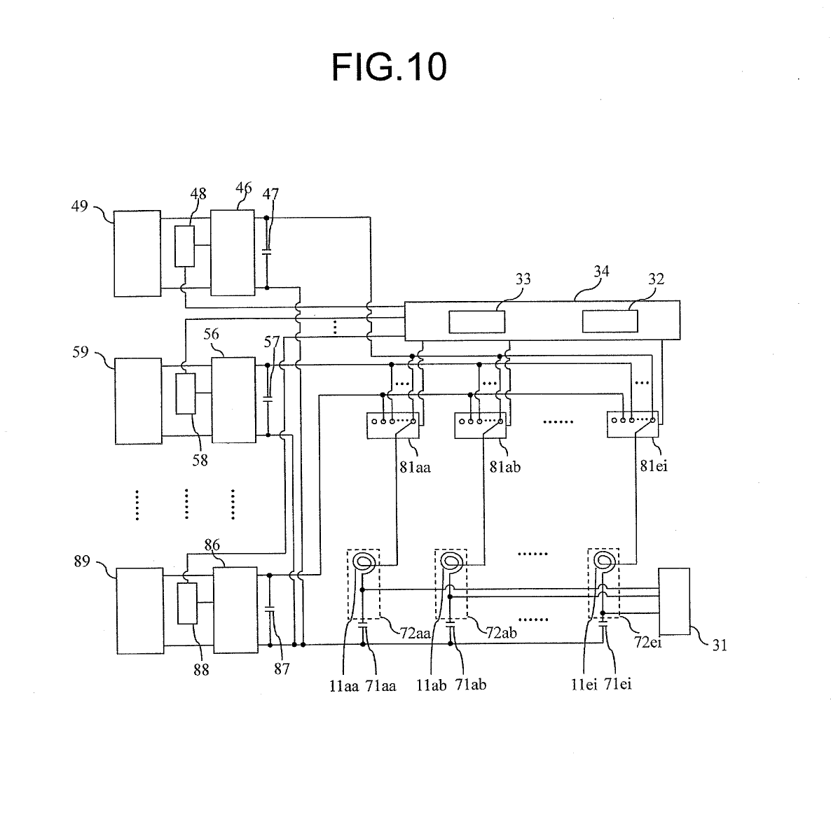

FIG. 9 illustrates placement of heating coils in an induction heater in the fourth exemplary embodiment and grouping of heating coils forming electric paths with the same inverter at turning on the main power. FIG. 10 is a circuit block diagram of the induction heater in the exemplary embodiment.

As shown in FIG. 9, induction heater 20 in the exemplary embodiment includes 45 heating coils aligned in a matrix of five lines and nine rows beneath cooktop 13, and operation panel 12 provided on cooktop 13. In FIG. 9, only three out of 45 heating coils are given reference marks (11aa, 11ab, and 11ei).

Heating coil group 101 is configured with ten heating coils including heating coil 11aa and heating coil 11ab. Heating coil group 105 is configured with ten heating coils including heating coil 11ei.

In the same way, heating coil groups 102, 103, and 104 are configured with ten heating coils, five heating coils, and ten heating coils, respectively.

In the initial state at turning on the main power, inverter 46 forms electric paths with ten heating coils included in group 101. Inverter 56 and inverter 86 form electric paths with heating coils in group 102 and group 105, respectively.

Although not illustrated in FIG. 10, inverter 66 and inverter 76 form electric paths with five heating coils in group 103 and ten heating coils in group 104, respectively.

Same as induction heater 10 in the first to third exemplary embodiments, each inverter is configured by connecting in series two switching elements (not illustrated) to which reverse conducting diodes are connected in parallel.

Power from commercial AC power source (not illustrated) is rectified and smoothed to supply power from five DC power supplies, including DC power source 49, DC power source 59, and DC power source 89, to corresponding inverters, respectively.

Based on a command signal from command unit 33, five drive circuits, including drive circuit 48, drive circuit 58, and drive circuit 88, drive corresponding inverters, respectively.

A snubber capacitor is provided on each of inverter output terminals. Snubber capacitor 47, snubber capacitor 57, and snubber capacitor 87 are illustrated in FIG. 10.

A resonance capacitor is connected to one end of each heating coil to configure 45 resonance circuits. FIG. 10 shows resonance capacitor 71aa, resonance capacitor 71ab, resonance capacitor 71ei, resonance circuit 72aa, resonance circuit 72ab, and resonance circuit 72ei.

A switching circuit is connected to the other end of each of the heating coils, respectively. FIG. 10 shows switching circuit 81aa, switching circuit 81ab, and switching circuit 81ei.

Each switching circuit determines an electric path between each heating coil and each inverter so that each heating coil forms an electric path with any of or none of the inverters.

Sensor group 31 is configured with 45 sensors. Each sensor detects voltage generated in each resonance capacitor and current running in each resonance circuit, respectively.

Container detection unit 32 determines whether or not a heating target is placed on each heating coil based on a detection result of each sensor in sensor group 31.

Command unit 33 receives a command signal from operation panel 12 to output a signal to five drive circuits for controlling to supply power to switching elements and control five inverters. Command unit 33 outputs a signal for switching connection of each switching circuit based on a detection result of container detection unit 32. Container detection unit 32 and command unit 33 are included in control unit 34 configured with a microcomputer.

For a heating coil on which a heating target is placed but induction heating is not yet started, container detection unit 32 handles it in the same way as a heating coil on which no heating target is placed, and supplies the container detecting current. This enables container detection unit 32 to recognize any change if the heating target is moved before induction heating.

In other words, container detection unit 32 sequentially and repetitively supply the container detecting current to a heating coil on which no heating target is placed and a heating coil on which a heating target is placed but heating has not yet started, so as to detect a container.

A response from the resonance circuit relative to supplied induction heating current changes if the heating target on a heating coil applying induction heat to it is moved,. Container detection unit 32 can detect this change by reading an output from the sensor, and thus movement of the heating target is recognizable.

In this case, command unit 33 outputs an instruction signal for stopping heating based on the container detection result of container detection unit 32.

The operation of the induction heater in the exemplary embodiment as configured above is described below.

When the main power is turned on, each inverter sequentially and repetitively supplies the container detecting current to heating coils in a corresponding group.

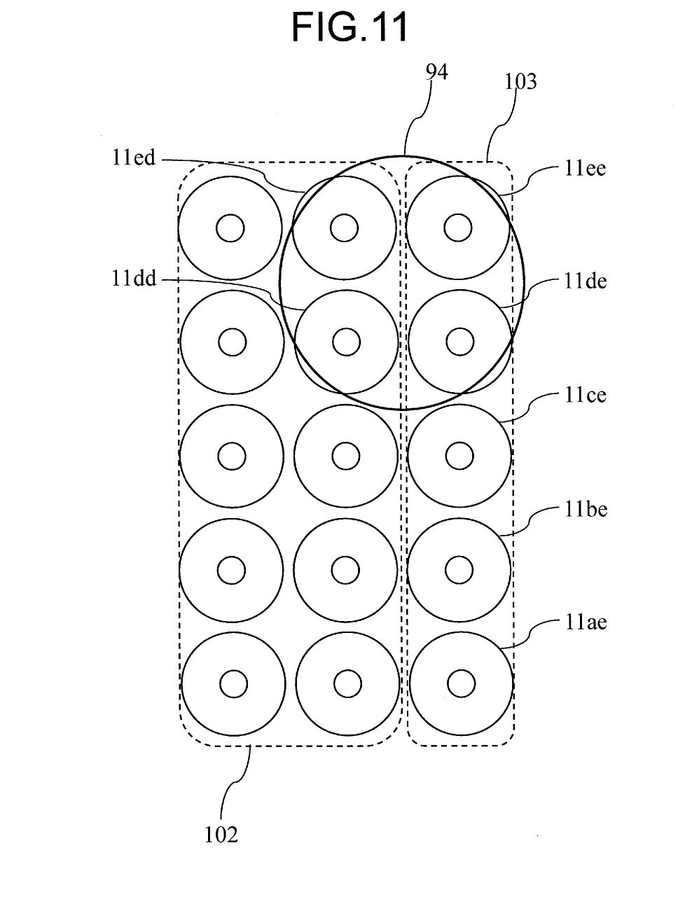

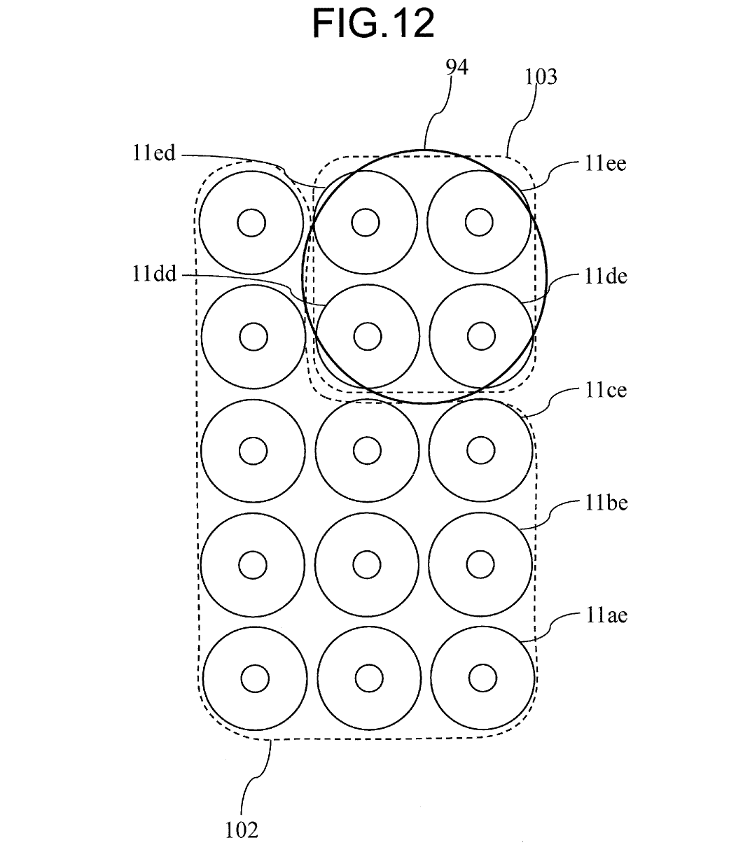

FIGS. 11 and 12 are fragmentary magnified views of FIG. 9 to illustrate how heating target 94 is placed on cooktop 13 of induction heater 20.

As shown in FIG. 11, if heating target 94 is placed across four heating coils, container detection unit 32 determines that heating target 94 is placed on heating coil 11dd and heating coil 11ed in group 102 and heating coil 11de and heating coil 11ee in group 103 based on an output of each sensor relative to the container detecting current.

In response to this detection result of container detection unit 32, command unit 33 switches applicable switching circuits to transfer heating coils 11dd and 11ed to group 103, and heating coil 11ae, heating coil 11be, and heating coil 11ce in group 103 but no heating target 94 is placed to group 102.

In this state, if an instruction for starting heating is given via operation panel 12, command unit 33 makes inverter 66 covering group 103 start supplying the induction heating current to heating coils 11dd, 11de, 11ed, and 11ee in group 103. Accordingly, induction heater 20 drives four heating coils by inverter 66 to apply induction heat to heating target 94.

To monitor whether or not another heating target is placed on 41 heating coils in groups 101, 102, 104, and 105 during induction heating, command unit makes inverters 46, 56, 76, and 86 repetitively supply the container detecting current to each heating coil in corresponding groups.

In the exemplary embodiment, inverter 66 supplies the induction heating current only to the four heating coils on which heating target 94 is placed, and the container detecting current to other heating coils.

This enables to prevent a conduction loss due to supply of the unrequired induction heating current to heating coils on which no heating target is placed and suppress a leaked magnetic field.

Since the container detecting current is supplied to the heating coils without heating target, placement of another heating target on these heating coils can be detected.

The switching circuit may be switched in response to container detection by container detection unit 32 or in response to a command signal for starting heating from command unit 33.

In the former case, switching takes place every time the heating target is moved, and this may be a wasteful operation, For example, if the switching circuit is a relay circuit, unrequired switching operation increases a risk of failure in addition to a clicking noise generated every time. Accordingly, command unit 33 preferably switches the switching circuit immediately before starting heating in response to an instruction for starting from operation panel 12.

The exemplary embodiment enables to apply induction heat separately to five heating targets at maximum. In this case, a heating coil without a heat target does not form an electric path with any of the inverters by switching applicable switching circuit so that no unrequired induction heating current is supplied to the heating coil without heating target.

The exemplary embodiment enables to execute the same operation as aforementioned exemplary embodiments to achieve the same effect in the induction heater equipped with inverters of the number one less than that of heating coils at maximum.

The exemplary embodiment includes 45 heating coils grouped as shown in FIG. 9 as the initial state at turning on the power. This grouping can be determined as required depending on the number of inverters, number of heating coils, positions, frequency of use, and so on. Therefore, grouping is not limited to that in the exemplary embodiment.

As long as the same functions are achieved, a DC power supply and inverters may have any structure. For example, a structure equipped with one system of the DC power supply and power may be supplied to all inverters from the DC power supply.

In the exemplary embodiment, 45 heating coils are aligned in matrix of five lines and nine rows. However, the present invention is not limited to this structure. For example, a line of heating coils may be shifted to left-hand or right-hand alternately. This also achieves the same effect as that of the exemplary embodiment.

### Fifth Exemplary Embodiment

An induction heater in the fifth exemplary embodiment of the present invention is described below.

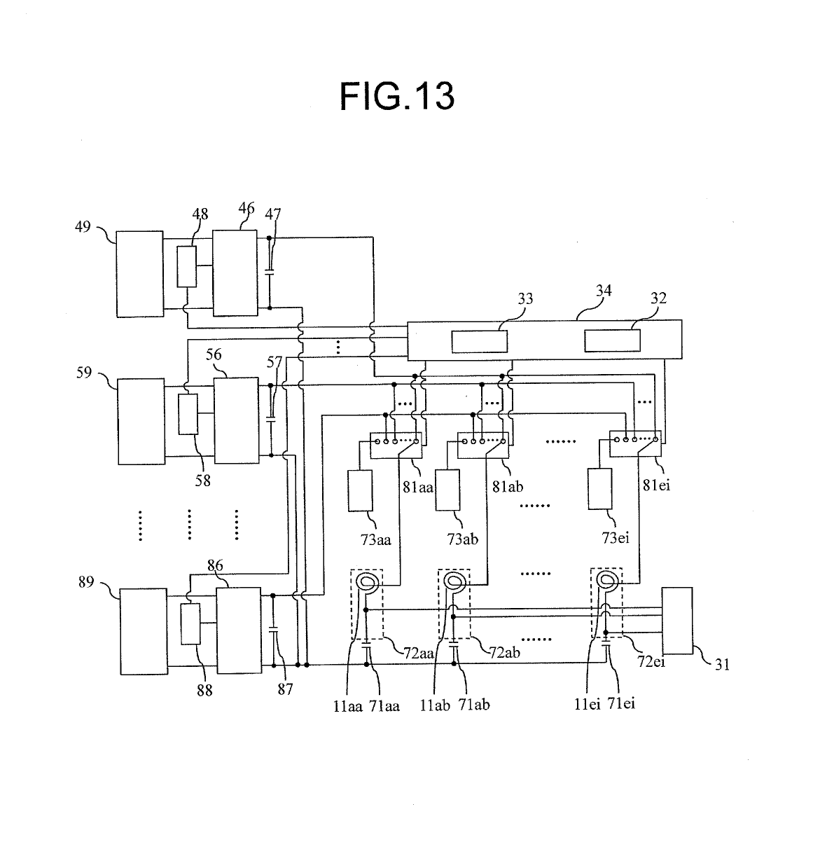

FIG. 13 is a circuit block diagram of the induction heater in the exemplary embodiment. A point different from FIG. 10 in FIG. 13 is that 45 auxiliary circuits are provided. However, in the drawing, only auxiliary circuit 73aa, auxiliary circuit 73ab, and auxiliary circuit 73ei are illustrated.

These 45 auxiliary circuits are connected to 45 switching circuits, respectively, and supply the container detecting current to corresponding heating coils via switching circuits, respectively. For auxiliary circuits, specifications sufficient for supplying induction heating current are not required.

The exemplary embodiment enables to apply induction heat to five heating targets separately at maximum. In this case, the container detecting current can be supplied from corresponding auxiliary circuit to a heating coil on which no heating target is placed.

Accordingly, placement of another heating target is detectable, and electric paths are restructured as required to execute induction heating separately in each of restructured groups.

### INDUSTRIAL APPLICABILITY

The present invention enables to operate only required heating coils, depending on placement of a heating target, by switching connection of heating coils and inverters by using inverters of the number less than that of heating coils in the induction heater equipped with a plurality of heating coils. This prevents from supplying the unrequired induction heating current to a heating coil on which no heating target is placed.

Accordingly, the present invention is effectively applicable, in particular, to home-use and industrial use induction heat cooking devices because cost can be reduced while maintaining safety of device, compared to those equipped with dedicated inverter for each heating coil.

### REFERENCE MARKS IN THE DRAWINGS

10, 20 Induction heater
11a, 11b, 11c, 11aa, 11ab, 11ae, 11be, 11ce, 11dd, 11de, 11ed, 11ee,
11ei Heating coil
12 Operation panel
13 Cooktop
21, 31 Sensor group
21a, 21b, 21c Sensor
22, 32 Container detection unit
23, 33 Command unit
24, 34 Control unit
40 AC power source
41, 51 Diode bridge
42, 52 Choke coil
43, 53 Smoothing capacitor
44, 45, 54, 55 Switching element
46, 56, 66, 76, 86 Inverter
47, 57, 87 Snubber capacitor
48, 58, 88 Drive circuit
49, 59, 89 DC power source
71a, 71b, 71c, 71aa, 71ab, 71ei Resonance capacitor
72, 72b, 72c, 72aa, 72ab, 72ei Resonance circuit
73aa, 73ab, 73ei Auxiliary circuit
81a, 81b, 81c, 81aa, 81ab, 81ei Switching circuit
91, 92, 93, 94 Heating target
101, 102, 103, 104, 105 Group

What is claimed is:

1. An induction heater comprising:
a cooktop on which a heating target is placed;
a plurality of heating coils including first and second heating coils, placed beneath the cooktop;
a plurality of inverters including first and second inverters configured to supply power to the heating coils;
a plurality of switching circuits configured to switch electric paths of the heating coils so that each of the heating coils is connected to any of or none of the inverters;
a command unit configured to control power supply from the inverters and switching of the switching circuits;
a sensor configured to detect a response of a resonance circuit including one of the plurality of heating coils, relative to power supply from the inverters; and
a container detection unit configured to detect presence of the heating target on each of the heating coils based on an output of the sensor,
wherein
a number of the plurality of inverters is less than a number of the plurality of heating coils, and
the command unit switches the switching circuits such that one of the first heating coil and the second heating coil is not connected to the first inverter when the container detection unit detects presence of the heating target on the first heating coil and absence of the heating target on the second heating coil in a configuration that at least the first and second heating coils form electric paths with the first inverter.

2. The induction heater of claim 1,
wherein
the command unit switches the switching circuits such that the first heating coil forms an electric path with the first inverter and the second heating coil forms an electric path with the second inverter.

3. The induction heater of claim 1,
wherein
the command unit switches the switching circuits such that at least two adjacent heating coils of the plurality of heating coils form an electric path with the first inverter when the container detection unit determines that a single heating target is placed across the at least two adjacent heating coils.

4. The induction heater of claim 3,
wherein
the command unit switches the switching circuits such that at least one of the at least two adjacent heating coils forms an electric path with the second inverter when power supplied by the first inverter to the at least two adjacent heating coils exceeds a specified value.

5. The induction heater of claim 1,
wherein
the command unit switches the switching circuits such that a heating coil, on which no heating target is placed, of the plurality of heating coils does not form an electric path with any of the inverters when all inverters are operated.

6. The induction heater of claim 5, further including an auxiliary circuit configured to supply container detecting current but not induction heating current,
wherein
the command unit switches the switching circuits such that the heating coil, on which no heating target is placed, forms an electric path with the auxiliary circuit.

7. The induction heater of claim 1, further comprising an operation part configured to give the command unit an instruction to start and stop heating,
wherein
the command unit switches the switching circuits in response to an instruction for starting heating given from the operation part.
